(19) United States
(12) Patent Application Publication
(10) Pub. No.: US 2012/0016056 A1
(43) Pub. Date: Jan. 19, 2012

(54) RUBBER COMPOSITION FOR TREAD AND PNEUMATIC TIRE

(76) Inventor: Tatsuya MIYAZAKI, Kobe-shi (JP)

(21) Appl. No.: 13/183,720

(22) Filed: Jul. 15, 2011

(30) Foreign Application Priority Data
Jul. 16, 2010 (JP) 2010-162150
Apr. 12, 2011 (JP) 2011-088557

(51) Int. Cl. C08J 5/14; C08L 93/04; C08L 45/00; C08L 9/06; C08L 45/02

(52) U.S. Cl. 523/156

(57) ABSTRACT

An object of the present invention is to provide a rubber composition for a tread which can improve fuel economy, grip performance (in particular, wet grip performance), abrasion resistance and handling stability in a balanced manner, and a pneumatic tire produced using the rubber composition. The present invention relates to a rubber composition for a tread, including a molten mixture of a solid resin having a softening point of not lower than 40° C. and at least one softener selected from the group consisting of oils, liquid coumarone-indene resins, and liquid indene resins, and the molten mixture having a mass ratio of the solid resin to the softener of 90/10 to 50/50.

### TECHNICAL FIELD

The present invention relates to a rubber composition for a tread, and a pneumatic tire produced using the rubber composition.

### BACKGROUND ART

In recent years, in view of environmental protection, there is a demand for improving the fuel economy of tires for automobiles by reducing rolling resistance. In addition, in view of performances such as safety and durability, higher levels of grip performance (in particular, wet grip performance), abrasion resistance and handling stability are also desired. These tire performances are largely based on the performance of tread. Therefore, many studies on improvement of a rubber composition for a tread have been made.

Regarding these performances, for example, lower rolling resistance and higher wet grip performance are in conflict with each other. One proposed attempt to improve these performances is to use silica, a modified rubber and a highly reactive silane coupling agent. However, silica tends to reduce abrasion resistance because silica generally has a lower affinity with a rubber component and therefore brings a smaller reinforcing effect, compared to carbon black.

Patent Document 1 teaches use of a resin such as a coumarone resin, a petroleum resin and/or a phenolic resin in combination with styrene-butadiene rubber in order to produce a tire rubber composition with improved grip performance. Still, it is difficult to improve fuel economy, grip performance (in particular, wet grip performance), abrasion resistance and handling stability in a balanced manner, and further improvement is still desired.

Patent Document 1: JP 2005-350535 A

### SUMMARY OF THE INVENTION

The present invention aims to solve these problems and to provide a rubber composition for a tread which can improve fuel economy, grip performance (in particular, wet grip performance), abrasion resistance and handling stability in a balanced manner, and a pneumatic tire produced using the rubber composition.

The present invention relates to a rubber composition for a tread, including a molten mixture of a solid resin having a softening point of not lower than 40° C. and at least one softener selected from the group consisting of oils, liquid coumarone-indene resins, and liquid indene resins, and

the molten mixture having a mass ratio of the solid resin to the softener of 90/10 to 50/50.

The solid resin is preferably at least one selected from the group consisting of aromatic vinyl polymers of α-methylstyrene and/or styrene, coumarone-indene resins, indene resins, terpene resins, and rosin resins.

The molten mixture is preferably in a solid form at room temperature.

Preferably, the rubber composition further includes styrene-butadiene rubber and silica. The styrene-butadiene rubber is preferably a solution-polymerized styrene-butadiene rubber end-modified with a modifying agent.

The present invention also relates to a pneumatic tire having a tread produced from the above rubber composition.

The rubber composition for a tread according to the present invention includes a molten mixture of a solid resin having a specific softening point and a specific softener, and can be used to provide a pneumatic tire whose fuel economy, grip performance (in particular, wet grip performance), abrasion resistance and handling stability are improved in a balanced manner.

### BEST MODE FOR CARRYING OUT THE INVENTION

The rubber composition for a tread according to the present invention includes a molten mixture of a solid resin having a softening point of not lower than 40° C. and at least one softener selected from the group consisting of oils, liquid coumarone-indene resins, and liquid indene resins.

The rubber composition including a molten mixture that is prepared by melt-mixing the solid resin and the softener in advance makes it possible to remarkably improve wet grip performance and abrasion resistance and to reduce rolling resistance, compared to a rubber composition prepared by simply mixing such a solid resin and softener. Therefore, the rolling resistance property, wet grip performance, abrasion resistance and handling stability of tires can be improved in a balanced manner.

The rubber composition contains a rubber component. Examples of a rubber that may be contained in a rubber component include natural rubber (NR), epoxidized natural rubber (ENR), isoprene rubber (IR), butadiene rubber (BR), styrene-butadiene rubber (SBR), styrene-isoprene-butadiene rubber (SIBR), ethylene-propylene-diene rubber (EPDM), chloroprene rubber (CR) and acrylonitrile-butadiene rubber (NBR). Any of these may be used alone, or two or more of these may be used in combination. Particularly, SBR is preferably used because it improves the balance of the above performances. More preferably, SBR is used in combination with BR and/or NR.

SBR is not particularly limited, and examples thereof include SBRs commonly used in the tire industry, such as emulsion-polymerized styrene-butadiene rubber (E-SBR) and solution-polymerized styrene-butadiene rubber (S-SBR). Among the SBRs, solution-polymerized SBR is preferable because it provides excellent wet grip performance and rolling resistance property. A solution-polymerized SBR end-modified with a modifying agent (modified S-SBR) is more preferable.

Examples of modifying agents usable for modification of SBR include 3-aminopropyldimethylmethoxysilane, 3-aminopropylmethyldimethoxysilane, 3-aminopropylethyldimethoxysilane and 3-aminopropyltrimethoxysilane. Any of these may be used alone, or two or more of these may be used in combination. Particularly, 3-aminopropyltrimethoxysilane is suitable because it is easily coupled to the polymer and has a higher affinity with fillers.

SBR can be modified with such a modifying agent by conventionally known methods such as methods disclosed in JP H06-53768 B and JP H06-57767 B. For example, SBR and the modifying agent may be contacted with each other for the modification, and this can be achieved, for example, by adding the modifying agent to an SBR solution to cause the reaction therebetween.

The styrene content of SBR is preferably not less than 5% by mass, and more preferably not less than 15% by mass. A styrene content of less than 5% by mass tends to deteriorate grip performance. The styrene content is preferably not more than 45% by mass, and more preferably not more than 40% by mass. A styrene content of more than 45% by mass tends to deteriorate the rolling resistance property.

The styrene content herein is calculated by H¹-NMR analysis.

The amount of SBR is preferably not less than 40% by mass, and more preferably not less than 60% by mass, based on 100% by mass of the rubber component. An amount of SBR of less than 40% by mass tends to result in insufficient grip performance. The amount may be 100% by mass, but is preferably not more than 95% by mass, and more preferably not more than 85% by mass because performances are improved in a balanced manner by using other rubbers in combination.

Here, the later-described solid resin and softener are not included in the rubber component.

In the case that the rubber composition contains BR, the amount of BR is preferably not less than 10% by mass, and more preferably not less than 15% by mass, based on 100% by mass of the rubber component. An amount of BR of less than 10% by mass tends to lead to deterioration in abrasion resistance. The amount is preferably not more than 50% by mass, and more preferably not more than 35% by mass. An amount of BR of more than 50% by mass tends to deteriorate grip performance.

In the case that the rubber composition contains NR, the amount of NR is preferably not less than 10% by mass, and more preferably not less than 15% by mass, based on 100% by mass of the rubber component. An amount of NR of less than 10% by mass tends to lead to deterioration in the rolling resistance property. The amount is preferably not more than 50% by mass, and more preferably not more than 35% by mass. An amount of NR of more than 50% by mass tends to deteriorate grip performance.

The molten mixture used in the present invention is prepared by melt-mixing a solid resin having a softening point of not lower than 40° C. and at least one softener selected from the group consisting of oils, liquid coumarone-indene resins, and liquid indene resins.

The softening point of the solid resin is preferably not lower than 40° C., and more preferably not lower than 50° C. If the softening point is lower than 40° C., there is likely to be a problem of blocking during storage of the agent, or caking of the agent in a material measuring device or feed pipe for introduction into a Banbury mixer. The softening point is preferably not higher than 150° C., and more preferably not higher than 110° C. If the softening point is higher than 150° C., the resin is less likely to melt during the base mixing in a Banbury mixer, possibly resulting in deterioration in dispersibility.

The softening point herein is a temperature at which a ball drops in the measurement of a softening point defined in JIS K 6220 using a ring and ball softening point apparatus.

Suitable examples of the solid resin include aromatic vinyl polymers of α-methylstyrene and/or styrene, coumarone-indene resins, indene resins, terpene resins and rosin resins. Among these, aromatic vinyl polymers of α-methylstyrene and/or styrene, coumarone-indene resins and indene resins are preferable. These resins improve the balance of the above performances.

The aromatic vinyl polymer of α-methylstyrene and/or styrene (resin produced by polymerizing α-methylstyrene and/or styrene) contains styrene and/or α-methylstyrene as aromatic vinyl monomer(s) (unit(s)). This polymer may be a homopolymer of either monomer or may be a copolymer of both monomers. The aromatic vinyl polymer is preferably a homopolymer of α-methylstyrene or a copolymer of α-methylstyrene and styrene because they are economical and easy to process, and provide excellent wet grip performance.

The weight average molecular weight (Mw) of the aromatic vinyl polymer is preferably not less than 500, and more preferably not less than 800. An aromatic vinyl polymer with a Mw of less than 500 tends not to provide a sufficient effect of improving wet grip performance. The weight average molecular weight of the aromatic vinyl polymer is preferably not more than 3000, and more preferably not more than 2000. An aromatic vinyl polymer with a Mw of more than 3000 tends to decrease the dispersibility of a filler and therefore to deteriorate the rolling resistance property. The weight average molecular weight used herein is measured with a gel permeation chromatograph (GPC) (GPC-8000 series produced by Tosoh Corporation, detector: differential refractometer), and calibrated with polystyrene standards.

The coumarone-indene resin and the indene resin are a coal or petroleum resin containing coumarone having eight carbon atoms and indene having nine carbon atoms as principal monomers, and a coal or petroleum resin containing indene as a principal monomer, respectively. Specific examples thereof include vinyltoluene-α-methylstyrene-indene resins, vinyltoluene-indene resins, α-methylstyrene-indene resins and α-methylstyrene-vinyltoluene-indene copolymer resins.

The terpene resin is a resin that contains, as a principal monomer, a terpene compound having a terpene backbone such as a monoterpene, sesquiterpene or diterpene. Examples thereof include 6 -pinene resins, β-pinene resins, limonene resins, dipentene resins, β-pinene/limonene resins, aromatic modified terpene resins, terpene phenolic resins and hydrogenated terpene resins. Examples of the rosin resin include natural rosin resins (polymerized rosins) such as gum rosin, wood rosin and tall oil rosin, hydrogenated rosin resins, maleic acid-modified rosin resins, rosin-modified phenolic resins, rosin glycerol esters and disproportionated rosin resins. The natural rosin resins can be produced by processing pine resin and each is mainly composed of resin acids including abietic acid and pimaric acid.

Oils, liquid coumarone-indene resins and liquid indene resins that may be used as the softener are in a liquid form at a room temperature (23° C.)

The softening point of the softener is preferably not higher than 20° C., and more preferably not higher than 17° C. If the softening point is higher than 20° C., the liquid resin tends to cause more heat build-up, possibly resulting in reduced fuel economy. The lower limit of the softening point is not particularly limited, and the softening point is preferably not lower than −20° C., more preferably not lower than −5° C., and further more preferably not lower than 0° C. A softener with a softening point of lower than −20° C. tends to have a too low molecular weight and therefore to have a lower affinity with polymers.

Examples of the oils include petroleum process oils such as paraffinic process oil, aromatic process oil and naphthenic process oil. Particularly, aromatic process oil is preferable because of its high affinity with rubber (and its SP value closer to that of rubber).

The mass ratio of the solid resin and the softener (solid resin/softener) in the molten mixture is 90/10 to 50/50, and preferably 85/15 to 70/30. This is because when the softener which is in a liquid form at room temperature is added in an appropriate amount, the molten mixture of the solid resin and the softener is properly swollen in the rubber composition and therefore is likely to be easily incorporated with the rubber component. An amount of the solid resin of more than 90% by mass may make it difficult to uniformly mix the rubber component and the solid resin. An amount of the solid resin of less than 50% by mass may render the molten solid resin miscible with the oil, which may make it difficult to favorably disperse the solid resin in the rubber component.

The molten mixture can be prepared by mixing the solid resin and the softener at a temperature of not lower than the melting points of these. The conditions of melt mixing may be, for example, at 50° C. to 160° C. for 2 to 6 minutes (preferably at 80° C. to 130° C. for 3 to 5 minutes). The melt mixing can be performed using a known heater and mixer. For example, the molten mixture can be prepared by melting and stirring the solid resin and the softener in a water bath, an oil bath or the like with heating.

The prepared molten mixture is preferably in a solid form at a room temperature (23° C.). By kneading the solid mixture with the rubber component, the solid resin is dispersed well in the rubber component, which improves the rolling resistance property, wet grip performance and abrasion resistance in a balanced manner.

In the rubber composition of the present invention, the amount of the solid resin is preferably not less than 1 part by mass, and more preferably not less than 5 parts by mass, based on 100 parts by mass of the rubber component. If the amount is less than 1 part by mass, the effects of the present invention may not be provided. The amount of the solid resin is preferably not more than 25 parts by mass, and more preferably not more than 20 parts by mass. An amount of the solid resin of more than 25 parts by mass tends to result in blooming and thereby in reduced abrasion resistance because it is difficult to maintain such an amount of the solid resin in the polymers.

The amount of the softener is preferably not less than 10 parts by mass, and more preferably not less than 15 parts by mass, based on 100 parts by mass of the rubber component. An amount of the softener of less than 10 parts by mass tends to result in insufficient grip performance. The amount of the softener is preferably not more than 50 parts by mass, and more preferably not more than 30 parts by mass. An amount of the softener of more than 50 parts by mass tends to reduce abrasion resistance and to cause more heat build-up.

Here, another solid resin or softener may be further added in addition to that contained in the molten mixture. In this case, the above amounts mean the total amounts of the respective agents in the rubber composition.

The rubber composition of the present invention preferably contains silica. The silica improves fuel economy and wet grip performance, and thereby improves the balance of the above performances.

The silica preferably has an N₂SA of not less than 80 m²/g, and more preferably not less than 150 m²/g. An N₂SA of less than 80 m²/g may result in insufficient reinforcement, and thereby tends to deteriorate handling stability, abrasion resistance and rubber strength. The N₂SA of the silica is preferably not more than 220 m²/g, and more preferably not more than 200 m²/g. An N₂SA of more than 220 m²/g may remarkably increase the viscosity of the resulting rubber composition, possibly resulting in lower processability. In addition, such an N₂SA may make it difficult to improve the dispersibility of silica, and therefore tends to result in more heat build-up.

Here, the N₂SA of the silica is a value determined by the BET method in accordance with ASTM D3037-81.

The amount of the silica is preferably not less than 40 parts by mass, and more preferably not less than 50 parts by mass, based on 100 parts by mass of the rubber component. An amount of the silica of less than 40 parts by mass may only provide an insufficient rubber reinforcing effect. The amount is preferably not more than 150 parts by mass, and more preferably not more than 100 parts by mass. An amount of the silica of more than 150 parts by mass may lead to more heat build-up and lower processability because the silica is less likely to be dispersed well.

In the present invention, a silane coupling agent is preferably used in combination with the silica. Examples of the silane coupling agent include sulfide-type silane coupling agents, mercapto-type silane coupling agents, vinyl-type silane coupling agents, amino-type silane coupling agents, glycidoxy-type silane coupling agents, nitro-type silane coupling agents and chloro-type silane coupling agents. Preferable among these are sulfide-type silane coupling agents such as bis(3-triethoxysilylpropyl)tetrasulfide, bis(2-triethoxysilylethyl)tetrasulfide, bis(3-triethoxysilylpropyl)disulfide and bis(2-triethoxysilylethyl)disulfide. Particularly preferable is bis(3-triethoxysilylpropyl)disulfide.

The amount of the silane coupling agent is preferably not less than 2 parts by mass, and more preferably not less than 6 parts by mass, based on 100 parts by mass of the silica. The amount of the silane coupling agent is preferably not more than 15 parts by mass, and more preferably not more than 12 parts by mass. The silane coupling agent in an amount adjusted within such a range enables the silica to be sufficiently dispersed, which results in improved performances such as less heat build-up and higher abrasion resistance.

The rubber composition for a tread of the present invention preferably contains carbon black. The carbon black improves reinforcement and ultraviolet degradation resistance, and also improves rubber strength.

The nitrogen adsorption specific surface area (N₂SA) of the carbon black is preferably not less than 50 m²/g, and more preferably not less than 70 m²/g. An N₂SA of the carbon black of less than 50 m²/g may result in insufficient reinforcement, and thereby tends to deteriorate handling stability, abrasion resistance and rubber strength. The N₂SA of the carbon black is preferably not more than 150 m²/g, and more preferably not more than 120 m²/g. An N₂SA of the carbon black of more than 150 m²/g may deteriorate processability.

Here, the N₂SA of the carbon black is determined in accordance with the method A described in JIS K6217.

The amount of the carbon black is preferably not less than 5 parts by mass, and more preferably not less than 20 parts by mass, based on 100 parts by mass of the rubber component. The amount is preferably not more than 60 parts by mass, and more preferably not more than 40 parts by mass. The carbon black in an amount adjusted within such a range provides good reinforcement, ultraviolet degradation resistance and handling stability.

In the case that the rubber composition of the present invention contains both silica and carbon black, the silica content is preferably not less than 45% by mass, more preferably not less than 55% by mass, and further more preferably not less than 65% by mass, based on 100% by mass of the total of silica and carbon black. The silica content is preferably not more than 95% by mass, more preferably not more than 90% by mass, and further more preferably not more than 85% by mass, based on 100% by mass of the total of silica and carbon black. When the silica content is within such a range, fuel economy, wet grip performance, abrasion resistance and handling stability can be improved in a balanced manner.

The rubber composition of the present invention may optionally contain compounding ingredients conventionally used in the rubber industry, in addition to the aforementioned ingredients. Examples of the compounding ingredients include stearic acid, zinc oxide, antioxidants, sulfur, and vulcanization accelerators.

Examples of antioxidants include amine type antioxidants, quinoline type antioxidants, and monophenol type antioxidants. In particular, combined use of an amine type antioxidant and a quinoline type antioxidant is preferable.

Examples of amine type antioxidants include amine derivatives such as diphenylamines and p-phenylenediamines. Examples of diphenylamine derivatives include p-(p-toluenesulfonylamide)-diphenylamine and octylated diphenylamine. Examples of p-phenylenediamine derivatives include N-(1,3-dimethylbutyl)-N′-phenyl-p-phenylenediamine (6PPD), N-phenyl-N′-isopropyl-p-phenylenediamine (IPPD), and N,N′-di-2-naphthyl-p-phenylenediamine.

Examples of quinoline type antioxidants include polymerized 2,2,4-trimethyl-1,2-dihydroquinoline, and 6-ethoxy-2,2,4-trimethyl-1,2-dihydroquinoline.

The amount of the antioxidant is preferably 1 to 10 parts by mass, and more preferably 2 to 7 parts by mass, based on 100 parts by mass of the rubber component.

In the case of combined use of an amine type antioxidant and a quinoline type antioxidant, the mixture ratio of the amine type antioxidant and the quinoline type antioxidant (amine type/quinoline type (mass ratio)) is preferably 50/50 to 90/10, and more preferably 65/35 to 85/15.

Examples of sulfur include sulfur powder, precipitated sulfur, colloidal sulfur, insoluble sulfur, and highly dispersible sulfur.

The amount of the sulfur is preferably 0.5 to 5 parts by mass, and more preferably 1 to 3 parts by mass, based on 100 parts by mass of the rubber component.

Preferred examples of vulcanization accelerators include sulfenamide vulcanization accelerators (e.g. N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), N,N-diisopropyl-2-benzothiazole sulfenamide), and guanidine vulcanization accelerators (e.g. diphenylguanidine (DPG), diorthotolylguanidine, triphenylguanidine, orthotolylbiguanide, diphenylguanidine phthalate). In particular, combined use of TBBS and DPG is particularly preferable.

The amount of the vulcanization accelerator is preferably 1 to 10 parts by mass, and more preferably 2 to 6 parts by mass, based on 100 parts by mass of the rubber component.

The rubber composition of the present invention may be produced by a common method. Specifically, the rubber composition is produced, for example, by a method including kneading the aforementioned ingredients with a rubber kneading apparatus such as a Banbury mixer, a kneader, or an open roll mill, and then vulcanizing the resultant mixture. Preferably, the molten mixture is melted and sufficiently dispersed in the rubber composition at the highest temperature (about 180° C.) of the kneading process. This results in higher grip performance.

The pneumatic tire of the present invention may be produced by a common method using the above rubber composition. Specifically, before vulcanization, the rubber composition optionally containing other additives is extruded and processed into the shape of a tread, molded in a usual manner on a tire building machine, and then assembled with other tire components so as to form an unvulcanized tire. Then, the unvulcanized tire is heated and pressurized in a vulcanizer to produce a tire.

The pneumatic tire of the present invention may be suitably used, for example, as a tire for passenger vehicles or a tire for trucks and buses.

### EXAMPLES

The following will mention the present invention specifically with reference to Examples, but the present invention is not limited thereto.

The chemical agents used in Examples and Comparative Examples are listed below.

BR150B: BR150B, produced by Ube Industries, Ltd.

Modified S-SBR: HPR355 (end-modified with 3-aminopropyltrimethoxysilane, styrene content: 27% by mass), produced by JSR Corporation

NR: TSR20

Silica: Ultrasil VN3 (N₂SA: 175 m²/g), produced by Degussa

Carbon black: SHOBLACK N220 (N₂SA: 111 m²/g), produced by Cabot Japan K.K.

Silane coupling agent: Si266 (bis(3-triethoxysilylpropyl)disulfide), produced by Evonik Degussa

Antioxidant 6PPD: Antigen 6C (N-(1,3-dimethylbutyl)-N′-phenyl-p-phenylenediamine), produced by Sumitomo Chemical Co., Ltd.

Antioxidant TMQ: FLECTOL TMQ (polymerized 2,2,4-trimethyl-1,2-dihydroquinoline), produced by FLEXSYS

Stearic acid: Tsubaki, produced by NOF Corporation

Zinc oxide: Zinc White #2, produced by Mitsui Mining & Smelting Co., Ltd.

5% Oil-containing sulfur powder: 5% oil-treated sulfur powder (soluble sulfur containing 5% by mass of oil), produced by Tsurumi Chemical Industry Co., Ltd.

Vulcanization accelerator TBBS: Nocceler NS (N-tert-butyl-2-benzothiazolylsulfenamide), produced by Ouchi Shinko Chemical Industrial Co., Ltd.

Vulcanization accelerator DPG: Nocceler D (N,N-diphenylguanidine), produced by Ouchi Shinko Chemical Industrial Co., Ltd.

Aromatic vinyl polymer (SA85) (solid resin (1)): SYLVARES SA85 (copolymer of α-methylstyrene and styrene, softening point: 85° C., Mw: 1000), produced by Arizona chemical

C90 (solid resin (2)): NOVARES C90 (coumarone-indene resin, softening point: 85-95° C.), produced by Rutgers Chemicals

Indene resin (solid resin (3)): Nisseki Neopolymer L-90 (aromatic petroleum resin, softening point: 95° C.) p Terpene resin (solid resin (4)): SYLVARES TP115 (terpene phenolic resin, softening point: 115° C.), produced by Arizona chemical

Rosin resin (solid resin (5)): TSF25 (softening point: 75° C.), produced by Arakawa Chemical Industries Ltd.

TDAE oil: VivaTec 400 (Low PCA aromatic oil, softening point: −50° C. or lower), produced by H&R

Aromatic oil: Process X-140 (softening point: −50° C. or lower), produced by Japan Energy Corporation

C10: NOVARES C10 (liquid coumarone-indene resin, softening point: 10° C.), produced by Rutgers Chemicals

Mineral oil: PW-32 (softening point: −50° C. or lower), produced by Idemitsu Kosan Co., Ltd.

Liquid indene resin: special grade Nisseki Neopolymer (trial product) (aromatic petroleum resin, liquid at room temperature)

### (Preparation of Molten Mixture)

In Examples 1 to 13 and Comparative Examples 7 to 9, a molten mixture was prepared using the chemical agents in amounts shown in Table 1 or 2, specifically by heating the solid resin to 120° C. in an oil bath, adding the softening agent thereto, completely melting the mixture, stirring and mixing the resulting mixture for five minutes, and cooling the mixture with water. The prepared molten mixtures of Examples were in a solid form at a room temperature (23° C.)

### Examples and Comparative Examples

The chemical agents in amounts shown in Table 1 or 2, except the sulfur and vulcanization accelerators, were kneaded in a Banbury mixer at 150° C. for three minutes to give a kneaded mixture. Thereafter, the sulfur and vulcanization accelerators were added to the kneaded mixture and then mixed and kneaded with an open roll mill at 50° C. for five minutes to give an unvulcanized rubber composition. A portion of the unvulcanized rubber composition was press-vulcanized in a 2-mm-thick mold at 170° C. for 20 minutes to give a vulcanized rubber composition.

Another portion of the unvulcanized rubber composition was molded into the shape of a tread, and assembled with other tire components to form a tire. The tire was vulcanized at 170° C. for 10 minutes to give a test tire (tire size: 195/65R15).

The thus obtained vulcanized rubber compositions and test tires were evaluated as follows. Tables 1 and 2 show the results of the respective tests.

### (Viscoelasticity Test)

E* and tan δ were measured at a dynamic strain amplitude of 1%, a frequency of 10 Hz, and a temperature of 30° C. using a spectrometer produced by Ueshima Seisakusho Co., Ltd. A larger value of E* corresponds to a higher rigidity, which in turn corresponds to a higher level of handling stability. A smaller value of tan δ corresponds to less heat build-up, which in turn corresponds to a higher level of fuel economy.

### (Wet Grip Performance)

Each set of test tires was mounted on a domestic FR vehicle of 2000 cc displacement. The vehicle was driven on a water-sprinkled wet road (water film thickness: 1.0 mm±0.5, asphalt road) of a test course. Then, the brake was stepped on when the speed was 70 km/h, and the distance traveled until the vehicle stopped after braking the tires (stopping distance) was measured. The inverse number of the distance of each example was expressed as an index relative to a value of 100 representing the inverse number of Comparative Example 1. A larger index value corresponds to a higher level of wet grip performance.

### (On-Vehicle Abrasion Test)

Each set of test tires was mounted on all wheels of a vehicle (domestic FF vehicle of 2000 cc displacement), and the decrease in the depth of grooves in the tread pattern was measured after the vehicle had run about 30000 km on an asphalt test course. The decrease of Comparative Example 1 was regarded as 100 and the decrease of each example was expressed as an index based on the following equation. A larger index value corresponds to a higher level of abrasion resistance.

(Abrasion resistance index)=(Decrease of Comparative Example 1)/(Decrease of each example)×100

TABLE 1

| | | | Examples | | | | | | |
|---|---|---|---|---|---|---|---|---|---|
| | | | 1 | 2 | 3 | 4 | 5 | 6 | 7 |
| Chemical | Molten mixture | Use of molten mixture | Used | Used | Used | Used | Used | Used | Used |
| agents | | Kind of solid resin | (1) | (1) | (1) | (1) | (2) | (3) | (4) |
| (part(s) | | Kind of softener | TDAE | Aromatic | C10 | Mineral | Aromatic | Aromatic | Aromatic |
| by mass) | | | | oil | | oil | oil | oil | oil |
| | | Solid resin (part(s) by mass) | 10 | 10 | 10 | 10 | 10 | 10 | 10 |
| | | Softener (part(s) by mass) | 4 | 4 | 4 | 4 | 4 | 4 | 4 |
| | | Solid resin content ratio | 0.71 | 0.71 | 0.71 | 0.71 | 0.71 | 0.71 | 0.71 |
| | Solid resin | (1) Aromatic vinyl polymer | — | — | — | — | — | — | — |
| | (post-addition) | (2) C90 (coumarone-indene resin) | — | — | — | — | — | — | — |
| | | (3) Indene resin | — | — | — | — | — | — | — |
| | | (4) Terpene resin | — | — | — | — | — | — | — |
| | | (5) Rosin resin | — | — | — | — | — | — | — |
| | Softener | TDAE oil | 22 | 22 | 22 | 22 | 22 | 22 | 22 |
| | | Aromatic oil | — | — | — | — | — | — | — |
| | | C10 | — | — | — | — | — | — | — |
| | | Mineral oil | — | — | — | — | — | — | — |
| | | Liquid indene resin | — | — | — | — | — | — | — |
| | Rubber | BR150B | 25 | 25 | 25 | 25 | 25 | 25 | 25 |
| | component | Modified S-SBR(HPR355) | 75 | 75 | 75 | 75 | 75 | 75 | 75 |
| | | NR(TSR20) | — | — | — | — | — | — | — |
| | Silica | VN3 | 70 | 70 | 70 | 70 | 70 | 70 | 70 |
| | Carbon black | N220 | 30 | 30 | 30 | 30 | 30 | 30 | 30 |
| | Silane coupling | Si266 | 5.6 | 5.6 | 5.6 | 5.6 | 5.6 | 5.6 | 5.6 |
| | agent | | | | | | | | |
| | Antioxidant | 6PPD | 3 | 3 | 3 | 3 | 3 | 3 | 3 |
| | | TMQ | 1 | 1 | 1 | 1 | 1 | 1 | 1 |
| | Vulcanization | Stearic acid | 3 | 3 | 3 | 3 | 3 | 3 | 3 |
| | acceleration aid | Zinc oxide | 2.5 | 2.5 | 2.5 | 2.5 | 2.5 | 2.5 | 2.5 |
| | Cross-linking | 5% Oil-containing sulfur powder | 1.8 | 1.8 | 1.8 | 1.8 | 1.8 | 1.8 | 1.8 |
| | agent (sulfur, | TBBS | 2 | 2 | 2 | 2 | 2 | 2 | 2 |
| | vulcanization | DPG | 2 | 2 | 2 | 2 | 2 | 2 | 2 |
| | accelerator) | | | | | | | | |

| | | | | | | | | |
|---|---|---|---|---|---|---|---|---|
| Evaluation results | E* 30° C. | 7.7 | 7.7 | 7.7 | 7.5 | 7.5 | 7.6 | 7.6 |
| | Tan δ 30° C. | 0.255 | 0.259 | 0.248 | 0.248 | 0.277 | 0.268 | 0.241 |
| | Wet grip index | 106 | 109 | 109 | 105 | 103 | 104 | 106 |
| | Abrasion resistance index | 105 | 107 | 110 | 103 | 102 | 105 | 107 |

| | | | Examples | | | | | |
|---|---|---|---|---|---|---|---|---|
| | | | 8 | 9 | 10 | 11 | 12 | 13 |
| Chemical | Molten mixture | Use of molten mixture | Used | Used | Used | Used | Used | Used |
| agents | | Kind of solid resin | (5) | (1) | (1) | (1) | (1) | (1) |
| (part(s) | | Kind of softener | Aromatic | Aromatic | Aromatic | Aromatic | Aromatic | Liquid |
| by mass) | | | oil | oil | oil | oil | oil | indene |
| | | | | | | | | resin |
| | | Solid resin (part(s) by mass) | 10 | 10 | 10 | 10 | 10 | 10 |
| | | Softener (part(s) by mass) | 4 | 2 | 6 | 9 | 4 | 4 |
| | | Solid resin content ratio | 0.71 | 0.83 | 0.63 | 0.52 | 0.71 | 0.71 |
| | Solid resin | (1) Aromatic vinyl polymer | — | — | — | — | — | — |
| | (post-addition) | (2) C90 (coumarone-indene resin) | — | — | — | — | — | — |
| | | (3) Indene resin | — | — | — | — | — | — |
| | | (4) Terpene resin | — | — | — | — | — | — |
| | | (5) Rosin resin | — | — | — | — | — | — |
| | Softener | TDAE oil | 22 | 24 | 20 | 17 | 22 | 22 |
| | | Aromatic oil | — | — | — | — | — | — |
| | | C10 | — | — | — | — | — | — |
| | | Mineral oil | — | — | — | — | — | — |
| | | Liquid indene resin | — | — | — | — | — | — |
| | Rubber | BR150B | 25 | 25 | 25 | 25 | — | 25 |
| | component | Modified S-SBR(HPR355) | 75 | 75 | 75 | 75 | 75 | 75 |
| | | NR(TSR20) | — | — | — | — | 25 | — |
| | Silica | VN3 | 70 | 70 | 70 | 70 | 70 | 70 |
| | Carbon black | N220 | 30 | 30 | 30 | 30 | 30 | 30 |
| | Silane coupling | Si266 | 5.6 | 5.6 | 5.6 | 5.6 | 5.6 | 5.6 |
| | agent | | | | | | | |
| | Antioxidant | 6PPD | 3 | 3 | 3 | 3 | 3 | 3 |
| | | TMQ | 1 | 1 | 1 | 1 | 1 | 1 |
| | Vulcanization | Stearic acid | 3 | 3 | 3 | 3 | 3 | 3 |
| | acceleration aid | Zinc oxide | 2.5 | 2.5 | 2.5 | 2.5 | 2.5 | 2.5 |
| | Cross-linking | 5% Oil-containing sulfur powder | 1.8 | 1.8 | 1.8 | 1.8 | 1.8 | 1.8 |
| | agent (sulfur, | TBBS | 2 | 2 | 2 | 2 | 2 | 2 |
| | vulcanization | DPG | 2 | 2 | 2 | 2 | 2 | 2 |
| | accelerator) | | | | | | | |

| | | | | | | | |
|---|---|---|---|---|---|---|---|
| Evaluation results | E* 30° C. | 7.6 | 7.6 | 7.6 | 7.5 | 7.9 | 7.6 |
| | Tan δ 30° C. | 0.237 | 0.265 | 0.268 | 0.263 | 0.24 | 0.241 |
| | Wet grip index | 99 | 105 | 105 | 103 | 119 | 107 |
| | Abrasion resistance index | 102 | 104 | 104 | 103 | 96 | 108 |

TABLE 2

| | | | Comparative Examples | | | | | |
|---|---|---|---|---|---|---|---|---|
| | | | 1 | 2 | 3 | 4 | 5 | 6 |
| Chemical | Molten mixture | Use of molten mixture | Not used | Not used | Not used | Not used | Not used | Not used |
| agents | | Kind of solid resin | — | — | — | — | — | — |
| (part(s) | | Kind of softener | — | — | — | — | — | — |
| by mass) | | | | | | | | |
| | | Solid resin (part(s) by mass) | — | — | — | — | — | — |
| | | Softener (part(s) by mass) | — | — | — | — | — | — |
| | | Solid resin content ratio | — | — | — | — | — | — |
| | Solid resin | (1) Aromatic vinyl polymer | 10 | 10 | — | — | — | — |
| | (post-addition) | (2) C90 (coumarone-indene resin) | — | — | 10 | — | — | — |
| | | (3) Indene resin | — | — | — | 10 | — | — |
| | | (4) Terpene resin | — | — | — | — | 10 | — |
| | | (5) Rosin resin | — | — | — | — | — | 10 |
| | Softener | TDAE oil | 26 | 26 | 26 | 26 | 26 | 26 |
| | | Aromatic oil | — | — | — | — | — | — |
| | | C10 | — | — | — | — | — | — |
| | | Mineral oil | — | — | — | — | — | — |
| | | Liquid indene resin | — | — | — | — | — | — |
| | Rubber | BR150B | 25 | — | 25 | 25 | 25 | 25 |
| | component | Modified S-SBR(HPR355) | 75 | 75 | 75 | 75 | 75 | 75 |
| | | NR(TSR20) | — | 25 | — | — | — | — |
| | Silica | VN3 | 70 | 70 | 70 | 70 | 70 | 70 |
| | Carbon black | N220 | 30 | 30 | 30 | 30 | 30 | 30 |
| | Silane coupling | Si266 | 5.6 | 5.6 | 5.6 | 5.6 | 5.6 | 5.6 |
| | agent | | | | | | | |
| | Antioxidant | 6PPD | 3 | 3 | 3 | 3 | 3 | 3 |
| | | TMQ | 1 | 1 | 1 | 1 | 1 | 1 |
| | Vulcanization | Stearic acid | 3 | 3 | 3 | 3 | 3 | 3 |
| | acceleration aid | Zinc oxide | 2.5 | 2.5 | 2.5 | 2.5 | 2.5 | 2.5 |
| | Cross-linking | 5% Oil-containing sulfur powder | 1.8 | 1.8 | 1.8 | 1.8 | 1.8 | 1.8 |
| | agent (sulfur, | TBBS | 2 | 2 | 2 | 2 | 2 | 2 |
| | vulcanization | DPG | 2 | 2 | 2 | 2 | 2 | 2 |
| | accelerator) | | | | | | | |
| Evaluation results | | E* 30° C. | 7.5 | 7.6 | 7.6 | 7.5 | 7.4 | 7.7 |
| | | Tan δ 30° C. | 0.265 | 0.255 | 0.265 | 0.261 | 0.251 | 0.24 |
| | | Wet grip index | 100 | 109 | 94 | 95 | 96 | 92 |
| | | Abrasion resistance index | 100 | 82 | 95 | 95 | 100 | 95 |
| | | | Comparative Examples | | | | | |
| | | | 7 | 8 | 9 | 10 | 11 | 12 |
| Chemical | Molten mixture | Use of molten mixture | Used | Used | Used | Not used | Not used | Not used |
| agents | | Kind of solid resin | (1) | (1) | (1) | — | — | — |
| (part(s) | | Kind of softener | Aromatic | Aromatic | Aromatic | — | — | — |
| by mass) | | | oil | oil | oil | | | |
| | | Solid resin (part(s) by mass) | 10 | 10 | 10 | — | — | — |
| | | Softener (part(s) by mass) | 0.8 | 12 | 18 | — | — | — |
| | | Solid resin content ratio | 0.93 | 0.45 | 0.36 | — | — | — |
| | Solid resin | (1) Aromatic vinyl polymer | — | — | Gel form | 10 | 10 | 10 |
| | (post-addition) | (2) C90 (coumarone-indene resin) | — | — | — | — | — | — |
| | | (3) Indene resin | — | — | — | — | — | — |
| | | (4) Terpene resin | — | — | — | — | — | — |
| | | (5) Rosin resin | — | — | — | — | — | — |
| | Softener | TDAE oil | 25.2 | 14 | 8 | — | 13 | — |
| | | Aromatic oil | — | — | — | 26 | — | — |
| | | C10 | — | — | — | — | 13 | — |
| | | Mineral oil | — | — | — | — | — | 26 |
| | | Liquid indene resin | — | — | — | — | — | — |
| | Rubber | BR150B | 25 | 25 | 25 | 25 | 25 | 25 |
| | component | Modified S-SBR(HPR355) | 75 | 75 | 75 | 75 | 75 | 75 |
| | | NR(TSR20) | — | — | — | — | — | — |
| | Silica | VN3 | 70 | 70 | 70 | 70 | 70 | 70 |
| | Carbon black | N220 | 30 | 30 | 30 | 30 | 30 | 30 |
| | Silane coupling | Si266 | 5.6 | 5.6 | 5.6 | 5.6 | 5.6 | 5.6 |
| | agent | | | | | | | |
| | Antioxidant | 6PPD | 3 | 3 | 3 | 3 | 3 | 3 |
| | | TMQ | 1 | 1 | 1 | 1 | 1 | 1 |
| | Vulcanization | Stearic acid | 3 | 3 | 3 | 3 | 3 | 3 |
| | acceleration aid | Zinc oxide | 2.5 | 2.5 | 2.5 | 2.5 | 2.5 | 2.5 |
| | Cross-linking | 5% Oil-containing sulfur powder | 1.8 | 1.8 | 1.8 | 1.8 | 1.8 | 1.8 |
| | agent (sulfur, | TBBS | 2 | 2 | 2 | 2 | 2 | 2 |
| | vulcanization | DPG | 2 | 2 | 2 | 2 | 2 | 2 |
| | accelerator) | | | | | | | |

| | | | | | | | |
|---|---|---|---|---|---|---|---|
| Evaluation results | E* 30° C. | 7.5 | 7.7 | 7.5 | 7.6 | 7.4 | 7.4 |
| | Tan δ 30° C. | 0.263 | 0.259 | 0.267 | 0.278 | 0.251 | 0.254 |
| | Wet grip index | 101 | 102 | 100 | 102 | 95 | 92 |
| | Abrasion resistance index | 101 | 100 | 100 | 101 | 104 | 95 |

As is clearly shown in Tables 1 and 2, use of the molten mixture of the solid resin and the softener according to the present invention remarkably improves wet grip performance and abrasion resistance and also improves tan δ and E*.

1. A rubber composition for a tread, comprising a molten mixture of a solid resin having a softening point of not lower than 40° C. and at least one softener selected from the group consisting of oils, liquid coumarone-indene resins, and liquid indene resins, and
the molten mixture having a mass ratio of the solid resin to the softener of 90/10 to 50/50.

2. The rubber composition for a tread according to claim 1,
wherein the solid resin is at least one selected from the group consisting of aromatic vinyl polymers of α-methylstyrene and/or styrene, coumarone-indene resins, indene resins, terpene resins, and rosin resins.

3. The rubber composition for a tread according to claim 1,
wherein the molten mixture is in a solid form at room temperature.

4. The rubber composition for a tread according to claim 1, further comprising styrene-butadiene rubber and silica.

5. The rubber composition for a tread according to claim 4,
wherein the styrene-butadiene rubber is a solution-polymerized styrene-butadiene rubber end-modified with a modifying agent.

6. A pneumatic tire comprising a tread produced from the rubber composition according to any one of claims 1 to 5.
